(19) United States
(12) Patent Application Publication
(10) Pub. No.: US 2026/0348604 A1
(43) Pub. Date: Nov. 5, 2026

(54) PASSIVE GEOTHERMAL HEATING AND COOLING SYSTEM

(71) Applicant: Eric Edward Mize, Benton, LA (US)

(72) Inventor: Eric Edward Mize, Benton, LA (US)

(21) Appl. No.: 19/662,612

(22) Filed: Apr. 29, 2026

Related U.S. Application Data
(60) Provisional application No. 63/799,334, filed on May 2, 2025.

(51) Int. Cl. F24F 5/00

(52) U.S. Cl. CPC F24F 5/005

(57) ABSTRACT

A passive geothermal heating and cooling system is disclosed. The system includes a buried geothermal airflow core including a plurality of underground air-conveying pipes, each of the plurality of underground air-conveying pipes configured to exchange heat with surrounding soil and each including at least one Venturi accelerator configured to increase airflow generated by natural convection without powered compression. The system includes a thermal hub fluidly coupled to the buried geothermal airflow core and configured to receive air therefrom, the thermal hub includes at least one air filtration element and a distribution chamber. The system includes a climate interface module fluidly coupled to the thermal hub and an air conveyance assembly interconnects the buried geothermal airflow core, the thermal hub, and the climate interface module. The system is configured to deliver whole-building airflow using passive geothermal heat exchange with no continuous electricity consumption during normal operation after installation.

### CROSS REFERENCE TO RELATED APPLICATIONS

This application claims priority to and the benefit of U.S. Provisional Patent Application No. 63/799,334, filed May 2, 2025, which is incorporated herein by reference.

### TECHNOLOGICAL FIELD OF THE INVENTION

The present invention pertains, generally, to building heating, ventilation, and air conditioning systems. More particularly, the present invention relates to passive geothermal heating and cooling systems for residential and light-commercial structures, including systems that utilize natural convection and subsurface heat exchange to condition indoor air without powered refrigeration or compression. The systems and methods of the present subject matter integrate buried geothermal air-conveying conduits, Venturi-based passive airflow acceleration, modular surface air-handling structures, and retrofit-oriented ducting assemblies to deliver whole-building conditioned airflow. The present invention further relates to energy-independent HVAC architectures configured for long-term operation with minimal electrical consumption, adaptable installation in new or existing buildings, and sustainable climate control in grid-constrained or off-grid environments.

### BACKGROUND OF THE INVENTION

Heating, ventilation, and air conditioning (HVAC) systems are widely used to regulate indoor thermal comfort in residential and light-commercial buildings. Conventional HVAC systems typically rely on electrically powered compressors, fans, pumps, and refrigerants to condition air, resulting in significant energy consumption, ongoing operating costs, and dependence on reliable electrical infrastructure. Installation of such conventional HVAC systems commonly requires extensive ductwork, mechanical equipment, and electrical upgrades, which can be especially disruptive and costly when applied to existing homes not originally designed for modern HVAC systems.

In mild and mixed climates, many homes experience heating and cooling demands that do not require the full capacity of conventional compressor-based HVAC systems. Nevertheless, these HVAC systems are often oversized and inefficient during partial-load operation, leading to unnecessary energy use, increased equipment wear, and shortened service life. Furthermore, retrofitting conventional HVAC systems into existing homes frequently presents additional challenges, including limited space for duct routing, inadequate electrical capacity, and architectural constraints that necessitate invasive structural modification. As a result, many existing homes remain reliant on outdated, inefficient, or poorly performing climate-control solutions.

Geothermal heating and cooling systems have been explored as alternatives to conventional HVAC systems by exploiting the relatively stable temperatures present below ground level. Certain geothermal systems, including active ground-source heat pump systems, employ electrically driven circulation pumps and compressors in combination with subsurface piping, wells, or closed-loop fluid circuits to transfer thermal energy. Installation of such active geothermal systems typically requires deep drilling, extensive trenching, or permanent subsurface infrastructure that must be integrated at the time of construction. These installation requirements are technically complex, capital-intensive, and generally incompatible with retrofit scenarios, as they necessitate substantial excavation and invasive modification of existing foundations, slabs, or load-bearing structures. Consequently, most of the geothermal heating and cooling systems are impractical for deployment in existing residential buildings and have seen limited adoption as retrofit solutions.

In recent developments, passive geothermal or earth-tube systems have also been proposed, in which air is routed through buried conduits to exchange heat with surrounding soil prior to delivery indoors. While such passive geothermal or earth-tube systems may operate without powered compression, they often generate insufficient airflow under natural convection to support whole-building climate control. Additionally, such earth-tube systems suffer from moisture accumulation, condensation, and mold growth, and lack practical interfaces for delivering conditioned air into existing buildings without cutting foundations, opening walls, or installing extensive new ductwork.

Traditional passive cooling systems and passive geothermal systems are typically engineered for integration during new building construction and are generally incompatible with post-construction installation. Such systems often presume the availability of predefined subsurface installation zones, dedicated vertical routing paths, or purpose-built air-delivery interfaces that are not present in existing residential structures. In existing homes, implementing these systems commonly requires invasive structural modification, including cutting slabs, altering foundations, modifying load-bearing walls, or constructing new structural chases to route airflow components. These interventions increase installation complexity, cost, and occupant disruption, and frequently deter homeowners from adopting passive geothermal technologies. As a result, passive geothermal systems have experienced limited practical adoption in retrofit applications despite their theoretical efficiency and sustainability advantages.

Certain hybrid heating and cooling systems attempt to mitigate airflow limitations associated with passive geothermal designs by incorporating powered fans, blowers, or auxiliary heating elements. Although such active components may increase airflow or thermal output, they introduce electrical dependence and substantially alter system architecture from a passive configuration. Systems that incorporate powered components for baseline airflow generation require electrical infrastructure upgrades, increased maintenance, and ongoing energy consumption, undermining the benefits sought in geothermal and passive conditioning solutions. In retrofit scenarios, the addition of such components further complicates installation and integration with existing building envelopes. Consequently, hybrid systems often fail to provide a viable retrofit solution that preserves the energy independence, simplicity, and resilience associated with fully passive geothermal operation.

Accordingly, in light of the foregoing, there remains a need to overcome the limitations associated with conventional HVAC systems, active geothermal systems, and existing passive earth-tube designs. In particular, there is a need for a passive geothermal heating and cooling system that can be easily and economically retrofitted into existing homes without invasive structural modification, while still delivering airflow sufficient for whole-building thermal comfort. There is further a need for systems that minimize excavation, avoid major alterations to foundations or load-bearing structures, and integrate seamlessly with existing building envelopes. There remains a need for reliable, scalable, and energy-independent climate-control solutions that combine subsurface geothermal conditioning with modular, retrofit-compatible air-handling and distribution architectures suitable for existing residential and light-commercial buildings.

### SUMMARY OF THE INVENTION

It is one prospect of the present invention to provide a passive geothermal heating and cooling systems, devices, and methods for conditioning air in buildings without powered refrigeration or compressors, whereby the systems are designed to utilize buried geothermal airflow cores, Venturi-based passive airflow acceleration, modular surface air-handling components, and retrofit-compatible air conveyance assemblies to deliver whole-building airflow using passive geothermal heat exchange with no continuous electricity consumption during normal operation after installation.

The following presents a simplified summary of the present disclosure in a simplified form as a prelude to the more detailed description that is presented herein.

Therefore, in accordance with a preferred embodiment of the present invention, there is provided a passive geothermal heating and cooling system comprising a buried geothermal airflow core including a plurality of underground air-conveying pipes, each configured to exchange heat with surrounding soil and each including at least one Venturi accelerator configured to increase airflow generated by natural convection without powered compression. The system further includes a thermal hub fluidly coupled to the buried geothermal airflow core and configured to receive air therefrom, the thermal hub including at least one air filtration element and a distribution chamber.

In one embodiment, the system further includes a climate interface module fluidly coupled to the thermal hub and configured to deliver conditioned air into an interior space of a building, and an air conveyance assembly interconnecting the buried geothermal airflow core, the thermal hub, and the climate interface module. The system is configured to deliver whole-building airflow using passive geothermal heat exchange with no continuous electricity consumption during normal operation after installation.

In another embodiment, the buried geothermal airflow core comprises between three and ten underground air-conveying pipes arranged in a parallel airflow configuration, wherein each underground air-conveying pipe has an internal diameter between 8 inches and 16 inches.

In yet another embodiment, each Venturi accelerator comprises a taper from an inlet diameter to a smaller throat diameter at an angle between 45 degrees and 65 degrees, configured to accelerate airflow to between 750 CFM and 1,750 CFM per underground air-conveying pipe.

In one embodiment, the plurality of underground air-conveying pipes are buried at a depth between 2 feet and 8 feet below grade. The thermal hub may further comprise dual gable vents configured to provide a natural draft assist of between 25 CFM and 75 CFM, and may include a modular heat-exchange roof cap configured to provide supplemental heating using solar thermal absorption or phase-change materials.

In another embodiment, the climate interface module includes an access enclosure fixed to at least one of a wall and a foundation of the building, and the air conveyance assembly comprises an exterior vertical wall chase having a length between 5 feet and 10 feet and a conical flexible soffit transition expanding from a first profile to a second profile larger than the first profile, configured to route airflow into an upper cavity of the building.

In yet another embodiment, the system is configured to deliver between 3,900 CFM and 6,100 CFM of conditioned airflow.

In one embodiment, the buried geothermal airflow core is encased in a gravel backfill layer comprising a double-sided reflective aluminum foil insulation backer, and each underground air-conveying pipe includes a pipe cap disposed at a lowest subterranean point, the pipe cap comprising weeping holes configured to drain condensation into the gravel backfill layer.

In another embodiment, the buried geothermal airflow core, the thermal hub, the climate interface module, and the air conveyance assembly are structurally coupled via male bevel connections received within corresponding female couplings.

In yet another embodiment, the present invention provides a passive geothermal airflow device comprising a plurality of hollow subterranean conduits each sized to convey ambient air and exchange heat with surrounding earth, at least one Venturi airflow accelerator disposed within each conduit and configured to increase airflow velocity under natural convection conditions, a surface-mounted air handling enclosure fluidly coupled to the conduits and including an air filtration section, and a building interface outlet configured to convey air from the enclosure into an occupied space. The device is configured to operate as a self-contained air conditioning and heating apparatus without powered compressors or refrigerants.

In one embodiment, the hollow subterranean conduits are fabricated from polymeric or composite materials selected to reduce internal friction and moisture accumulation, and the surface-mounted air handling enclosure includes a removable filter tray. In further embodiments, the building interface outlet includes an insulated duct section configured for retrofit installation.

In another embodiment, the device further comprises at least one auxiliary component selected from the group consisting of a fan and a heater, wherein the auxiliary component is selectively operable and not required for baseline operation.

In yet another embodiment, the present invention provides a method of providing passive geothermal heating and cooling to a building. The method includes installing a plurality of air-conveying pipes underground at a depth sufficient to utilize stable ground temperatures, integrating at least one Venturi accelerator within each pipe to enhance airflow driven by natural convection, coupling the pipes to a surface thermal hub, filtering air received from the pipes within the thermal hub to produce filtered air, and routing the filtered air through an air conveyance assembly into an interior space of the building, whereby the method provides continuous air conditioning without powered refrigeration or compressors.

In one embodiment, the method further includes routing the air conveyance assembly through a vertical wall chase within the building and attaching a modular heat-exchange cap to the surface thermal hub to provide supplemental heating. The method enables retrofit installation and scalable passive operation while maintaining whole-building thermal comfort.

These and other features, aspects, embodiments, and advantages of the present invention will be better understood with reference to the following description and appended claims. This summary is provided to introduce a selection of concepts in a simplified form. This summary is not intended to identify key features or essential features of the claimed or disclosed invention, nor is it intended to be used to limit the scope of the claimed subject matter.

### BRIEF DESCRIPTION OF THE DRAWINGS

Having thus described example embodiments of the invention in general terms, the summary above, as well as the following detailed description of illustrative embodiments, is better understood when read in conjunction with the appended drawings. For the purpose of illustrating the present subject matter, exemplary constructions of the subject matter are shown in the drawings. However, the present subject matter is not limited to specific methods and instrumentalities disclosed herein. Moreover, those in the art will understand that the drawings are not to scale. Wherever possible, like elements have been indicated by identical numbers and the illustrative embodiments of the present invention are described herein, by way of example only, with reference to the accompanying drawings, and wherein:

FIG. 1A is a cross-sectional schematic view of a passive geothermal heating and cooling system, according to a preferred embodiment of the present invention;

FIG. 1B is a cross-sectional schematic view of the passive geothermal heating and cooling system, according to one embodiment of the present invention;

FIG. 1C is a cross-sectional schematic view of the passive geothermal heating and cooling system, according to another embodiment of the present invention;

FIG. 1D is a cross-sectional schematic view of a passive geothermal airflow device, in accordance with an embodiment of the invention;

FIG. 1E a top-down cross-sectional view of the buried geothermal airflow core configured in a multi-pipe arrangement, in accordance with an embodiment of the invention;

FIG. 1F is a close-up cutaway view of an upper portion of the buried geothermal airflow core illustrating the integrated Venturi accelerators, in accordance with an embodiment of the invention;

FIG. 2A is a front cutaway view of the thermal hub illustrating internal airflow handling and filtration components, in accordance with an embodiment of the invention;

FIG. 2B is a rear cutaway view of the thermal hub, in accordance with an embodiment of the invention;

FIG. 2C is a partial interior perspective view of the thermal hub illustrating the filter tray and access panel, in accordance with an embodiment of the invention;

FIG. 3 is an exploded perspective view of the climate interface module configured to route conditioned air, in accordance with an embodiment of the invention;

FIG. 4 is a sectional view of an AeroDuct soffit transition assembly, in accordance with an embodiment of the invention;

FIG. 5A illustrates an experimental scale mock-up of the passive geothermal heating and cooling system during a testing phase, specifically depicting a baseline ground temperature measurement, in accordance with an embodiment of the invention;

FIG. 5B illustrates the experimental scale mock-up of the passive geothermal heating and cooling system during the testing phase, specifically depicting an ambient reference temperature measurement, in accordance with an embodiment of the invention;

FIG. 5C illustrates the experimental scale mock-up of the passive geothermal heating and cooling system during the testing phase, specifically depicting a discharge air temperature measurement at the vent, in accordance with an embodiment of the invention;

FIG. 6 illustrates an observation setup used to evaluate operation of the system during passive or supplemental airflow conditions, in accordance with an embodiment of the invention;

FIG. 7 illustrates an example external environmental data display presented on a user-operated mobile device, showing historical and time-based atmospheric conditions relevant to operation of the passive geothermal system, in accordance with an embodiment of the present invention; and

FIG. 8 illustrates a flow chart of a method of providing passive geothermal heating and cooling to a building, in accordance with an embodiment of the present invention.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure, or manner. It should be understood that the devices, materials, methods, procedures, and techniques described herein are presently representative of various embodiments. Other embodiments of the disclosure will readily suggest themselves to such skilled persons having the benefit of this disclosure.

In overview, some embodiments of the present invention relate to passive geothermal heating and cooling systems and methods. The following detailed description illustrates various embodiments of the present invention and ways in which they can be implemented. Although some modes of carrying out the present invention have been disclosed, those skilled in the art would recognize that other embodiments for carrying out or practicing the present invention are also possible. Some disclosed embodiments include passive geothermal heating and cooling systems and methods that have been disclosed herein.

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or to other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments.

In an aspect, some embodiments of the present invention provide a passive geothermal heating and cooling system.

The passive geothermal heating and cooling system includes a buried geothermal airflow core which includes a plurality of underground air-conveying pipes. Each of the plurality of underground air-conveying pipes are configured to exchange heat with surrounding soil and each of the plurality of underground air-conveying pipes including at least one Venturi accelerator. The at least one Venturi accelerator is configured to increase airflow generated by natural convection without powered compression. The system includes a thermal hub fluidly coupled to the buried geothermal airflow core and is configured to receive air therefrom. The thermal hub included at least one air filtration element and a distribution chamber. The system also includes a climate interface module that is fluidly coupled to the thermal hub and is configured to deliver conditioned air into an interior space of a building. The system also includes an air conveyance assembly that interconnects the buried geothermal airflow core, the thermal hub, and the climate interface module. The system is configured to deliver whole-building airflow using passive geothermal heat exchange with no continuous electricity consumption during normal operation after installation.

In another embodiment of the present invention, a passive geothermal airflow device is presented. The passive geothermal airflow device includes a plurality of hollow subterranean conduits each sized to convey ambient air and exchange heat with surrounding earth. The device includes at least one Venturi airflow accelerator disposed within each of the plurality of hollow subterranean conduits and is configured to increase airflow velocity under natural convection conditions. The device further includes a surface-mounted air handling enclosure that is fluidly coupled to the plurality of hollow subterranean conduits. The surface-mounted air handling enclosure includes an air filtration section. The device includes a building interface outlet that is configured to convey air from the surface-mounted air handling enclosure into an occupied space. The device is configured to operate as a self-contained air conditioning and heating apparatus without powered compressors or refrigerants.

In yet another embodiment of the present invention, a method of providing passive geothermal heating and cooling to a building is presented. The method includes a first step of installing a plurality of air-conveying pipes underground at a depth sufficient to utilize stable ground temperatures. The method includes a second step of integrating at least one Venturi accelerator within each of the plurality of air-conveying pipes to enhance airflow driven by natural convection. The method includes a third step of coupling the plurality of air-conveying pipes to a surface thermal hub. The method includes a fourth step of filtering air received from the plurality of air-conveying pipes within the surface thermal hub to produce filtered air. The method includes a fifth step of routing the filtered air through an air conveyance assembly into an interior space of the building, wherein the method provides continuous air conditioning without powered refrigeration or compressors.

The following definitions apply to embodiments of the present invention.

A passive geothermal heating and cooling system refers to an integrated assembly of structural and fluidly connected components configured to condition air using subsurface thermal exchange rather than powered refrigeration. The system relies on naturally occurring temperature differentials between buried earth and ambient air. Airflow within the system is generated primarily by natural convection and pressure differentials rather than by compressors or continuous powered devices. Electrical components, if present, are not required for baseline operation. The system is intended to operate continuously after installation with minimal or no ongoing energy consumption.

A buried geothermal airflow core refers to a subsurface heat-exchange structure that includes multiple underground air-conveying pipes arranged to interact thermally with surrounding soil. The airflow core is positioned below grade to take advantage of stable ground temperatures across seasonal variations. Air passing through the airflow core exchanges thermal energy with the surrounding earth through the pipe walls. The airflow core acts as the primary conditioning stage for incoming air. Structural and drainage features may be integrated to maintain long-term performance.

Underground air-conveying pipes are elongated hollow conduits installed below ground and configured to permit airflow along their longitudinal axes. The pipes are sized and positioned to maximize surface contact with surrounding soil for heat exchange. Each pipe forms a defined passageway for air entering or exiting the system. The pipes may be arranged in parallel to distribute airflow and reduce resistance. The pipes may include integrated airflow-enhancing features.

A Venturi accelerator refers to an internal airflow-shaping structure formed within an air-conveying pipe that accelerates air using geometric tapering. The Venturi accelerator includes a convergence from a larger inlet diameter to a smaller throat diameter. This geometry increases airflow velocity under natural convection conditions without mechanical compression. The accelerator operates based on pressure and velocity differentials induced by airflow movement. The Venturi accelerator is fixed relative to the pipe structure.

Natural convention refers to airflow generated by density and pressure differences caused by temperature variation rather than mechanical force. Warmer air tends to rise while cooler air descends, creating directional movement. In the system, natural convection initiates and sustains airflow through the buried components. The system geometry and component arrangement enhance this naturally occurring phenomenon. No powered blower is required to initiate baseline airflow.

A thermal hub refers to a surface-located air-handling structure fluidly coupled to the buried geothermal airflow core. The thermal hub receives conditioned air from the underground components. The thermal hub serves as a collection, stabilization, and distribution point for airflow. Internal chambers within the thermal hub manage airflow direction and pressure. The thermal hub may support additional passive or optional modules.

An air filtration element refers to a removable or fixed structure positioned within an airflow path and configured to remove particulates from moving air. The filtration element may include fibrous, pleated, or layered media. Filtration protects downstream components and improves indoor air quality. The filtration element is positioned within the thermal hub in normal operation. The filtration element does not materially impede passive airflow.

A distribution chamber refers to an internal volume within the thermal hub configured to equalize pressure and redirect airflow. The distribution chamber allows air from multiple pipes to combine into a unified stream. Internal geometry reduces turbulence and promotes stable airflow. The distribution chamber directs air toward downstream components. The chamber is structurally integrated into the thermal hub.

A climate interface module refers to a structure that provides a transition between the system and interior occupied spaces. The climate interface module delivers conditioned air into the building. The module is positioned at or near a building boundary. It defines the interface between outdoor or subsurface airflow components and indoor environments. The module may house optional airflow accessories.

An air conveyance assembly refers to a set of ducts, chases, transitions, or conduits used to route air between system components. The assembly structurally interconnects the buried airflow core, thermal hub, and climate interface module. It defines airflow pathways through varying vertical and horizontal elevations. The assembly is designed to minimize airflow resistance. The assembly may be adapted for retrofit installation.

Whole-building airflow refers to a volumetric airflow rate sufficient to condition air throughout substantially all occupied spaces of a building. Whole-building airflow is greater than localized or room-only ventilation. It supports temperature equalization across multiple interior zones. Whole-building airflow is measured in cubic feet per minute. The system achieves such airflow under passive operation.

Parallel airflow configuration refers to an arrangement in which multiple air-conveying pipes operate simultaneously and independently along similar flow paths. Each pipe receives and conveys airflow without serial dependency on another pipe. The parallel arrangement reduces pressure loss and increases total system airflow. Airflow distribution across pipes is substantially balanced. The configuration enhances thermal exchange capacity.

Venturi taper angle refers to the angular relationship between the inlet section and throat section of a Venturi accelerator. The angle determines how rapidly airflow transitions between diameters. The selected angle influences airflow acceleration efficiency. Excessively shallow or steep angles may reduce effectiveness. The angle range is selected to balance airflow speed and pressure stability.

Burial depth refers to the vertical position of underground air-conveying pipes relative to a ground 141 surface. Burial depth determines exposure to stable soil temperatures. Shallower depths may experience higher temperature variability. Deeper depths improve thermal stability but increase installation effort. A defined depth range accommodates varying soil conditions.

Dual gable vents refer to paired vent openings formed in opposing or spaced portions of the thermal hub. The vents allow air exchange between the thermal hub and ambient environment. The vents create pressure differentials that assist airflow. The vents support passive draft effects without powered assistance. Airflow contribution is additive to subsurface convection.

A modular heat-exchange roof cap refers to an optional attachable structure positioned at an upper portion of the thermal hub. The roof cap is configured to absorb or store thermal energy. The roof cap may use solar radiation or latent heat storage materials. The roof cap is structurally removable and replaceable. The roof cap supplements but do not replace geothermal operation.

An access enclosure refers to structural housing mounted at a building interface point. The enclosure provides physical access to airflow components. It allows inspection and maintenance without disturbing primary system components. The enclosure supports secure coupling to building surfaces. The enclosure defines the air entry or exits boundary.

A gravel backfill layer refers to a granular substrate positioned around buried components. The backfill supports thermal exchange and drainage. Voids between gravel particles allow water migration. The backfill stabilizes piping against soil movement. The material selection reduces moisture accumulation.

Weeping holes refer to small drainage openings formed in pipe caps or low-point components. The holes permit condensate to escape by gravity. Weeping holes prevent standing water within pipes. Drainage occurs into surrounding backfill. The holes are passive and maintenance-free.

Male bevel and female coupling refer to complementary structural joining features. The male bevel is a tapered projection. The female coupling defines a receiving cavity shaped to accept the bevel. Together they form a frictional or snap-fit seal. The connection aligns airflow paths while reducing leakage.

A passive geothermal airflow device refers to a physical apparatus capable of conditioning air through subsurface heat exchange. The device includes buried conduits and surface air-handling components. The device operates without powered refrigeration cycles. Airflow enhancement is achieved structurally. The device functions as a standalone unit.

An auxiliary component refers to an optional powered element integrated into the system. Auxiliary components include fans or heaters. These components are selectively operable. They are not required for baseline passive operation. Their use enhances performance under particular conditions.

The proposed systems and methods improve building climate control by enabling whole-building heating and cooling through passive geothermal operation rather than powered refrigeration. By utilizing buried air-conveying pipes positioned to exchange heat with stable subsurface soil, the system conditions air using naturally available thermal energy. Integration of Venturi-based airflow acceleration within the buried pipes increases airflow generated by natural convection, allowing the system to achieve airflow levels sufficient for whole-building comfort without continuous electrical input. This approach reduces reliance on compressors, refrigerants, and high-power fans, thereby lowering operating costs, minimizing energy consumption, and improving reliability during power outages or grid instability. As a result, indoor thermal comfort can be maintained in a consistent and sustainable manner across residential and light-commercial buildings.

The modular architecture of the proposed system further improves adaptability, longevity, and practicality compared to conventional HVAC and prior passive geothermal approaches. Structural features such as the thermal hub, climate interface module, and air conveyance assembly allow controlled routing, filtration, and distribution of conditioned air while remaining compatible with retrofit installation in existing buildings. Moisture management features, including drainage through weeping holes and gravel backfill, mitigate condensation and mold risks commonly associated with earth-tube systems, supporting long-term performance and reduced maintenance. Optional supplemental components, such as fan or heating elements, may be selectively employed without altering baseline passive functionality, enabling adaptability to varying climates or usage conditions. Together, these features provide a scalable, energy-independent HVAC solution that improves efficiency, reduces lifecycle cost, and expands applicability to off-grid, grid-constrained, and sustainability-focused environments.

These and other features, aspects, embodiments, and advantages of the present invention will be better understood with reference to the below-stated description and appended claims. These definitions are provided to introduce a selection of concepts in a simplified form. These definitions are not intended to identify key features or essential features or keywords of the claimed or disclosed invention, nor are they intended to be used to limit the scope of the claimed invention.

The passive geothermal heating and cooling system and method as disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, and the like, may be made and may be desired for a specific application.

In the present invention, any identification of specific shapes, materials, techniques, arrangements, etc., is either related to a specific example presented or is merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to figures.

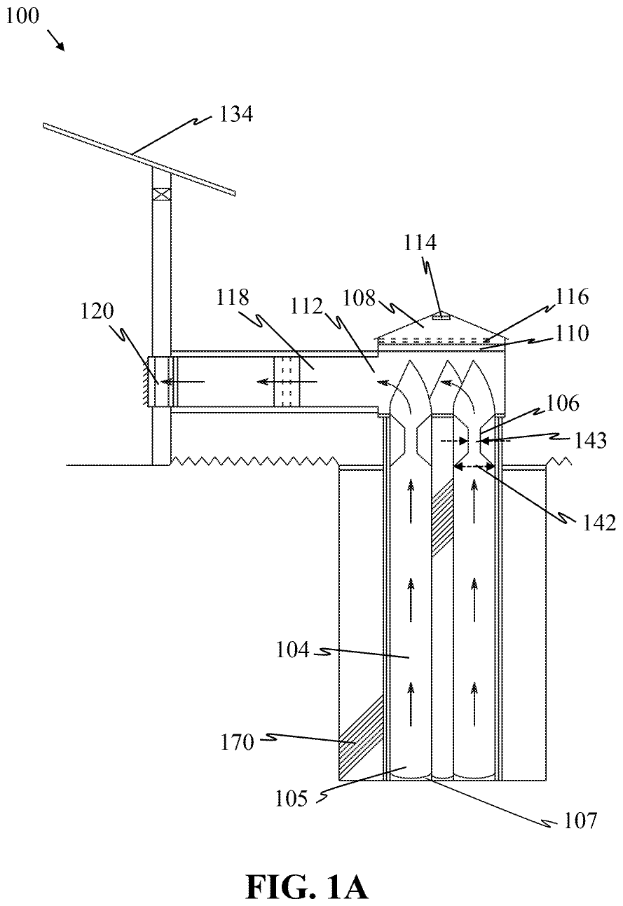

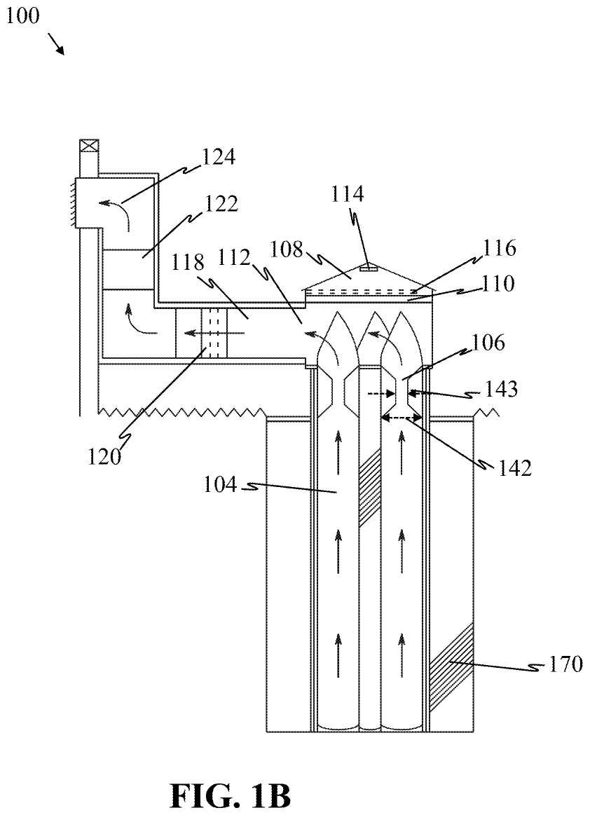

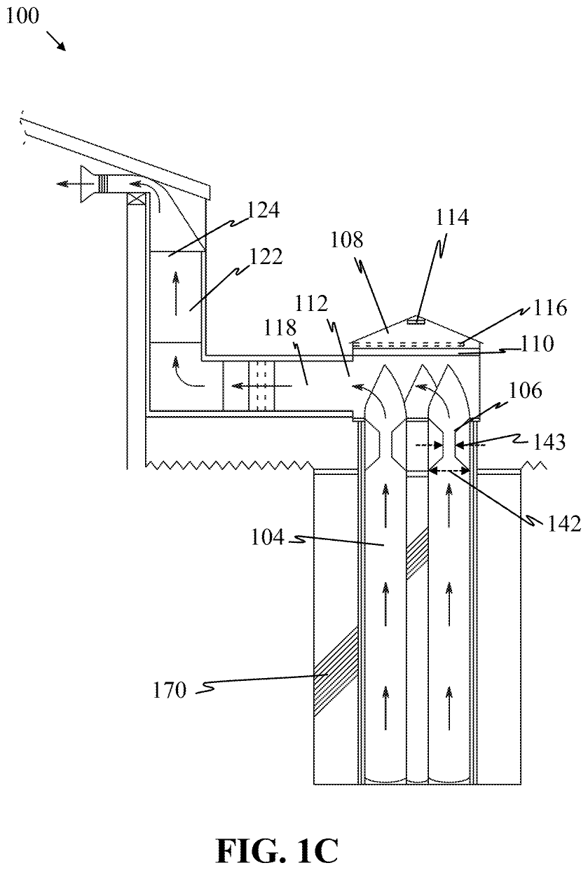

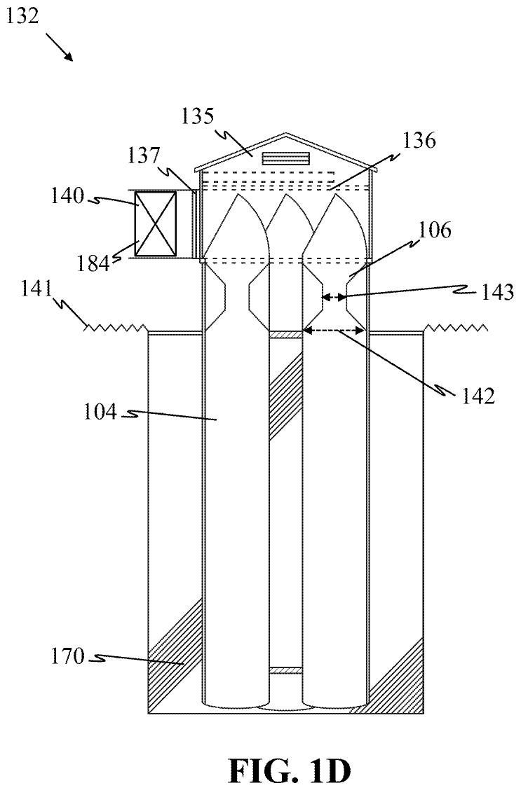

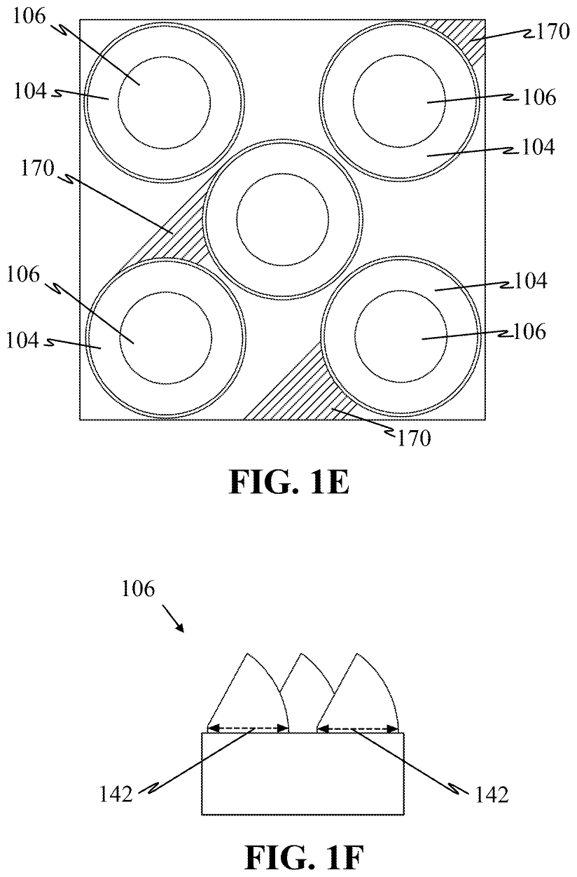

Referring to FIGS. 1A-1C, which are schematic views of a passive geothermal heating and cooling system 100, in accordance with a preferred embodiment of the present invention. The system 100 includes a buried geothermal airflow core 102 including a plurality of underground air-conveying pipes 104. Each of the plurality of underground air-conveying pipes 104 includes at least one Venturi accelerator 106. The system 100 includes a thermal hub 108 that includes at least one air filtration element 110 and a distribution chamber 112. In some embodiments, the thermal hub 108 also includes a plurality of dual gable vents 114 and a modular heat-exchange roof cap 116. The system 100 includes a climate interface module 118 including an access enclosure 120. The system 100 includes an air conveyance assembly 122 that includes an exterior vertical wall chase 124.

In another embodiment, the system 100 includes the buried geothermal airflow core 102 having the plurality of underground air-conveying pipes 104 positioned below grade to take advantage of the relatively stable temperatures of surrounding soil. As ambient air is drawn through the underground air-conveying pipes 104, thermal energy is exchanged across the pipe walls such that the air is cooled during warmer conditions and warmed during cooler conditions prior to reaching above-ground components. The use of multiple underground air-conveying pipes 104 increases total surface area in contact with the soil, thereby improving heat-exchange efficiency while distributing airflow to reduce resistance and pressure losses. Each of the underground air-conveying pipes 104 operates as part of a parallel airflow arrangement, allowing air to move simultaneously through multiple paths rather than sequentially through a single conduit. The buried geothermal airflow core 102 functions as the primary thermal conditioning stage of the system 100 and establishes baseline temperature modulation without reliance on powered refrigeration.

In yet another embodiment, each of the plurality of underground air-conveying pipes 104 includes the at least one Venturi accelerator 106 integrated within the internal airflow path to increase airflow generated by natural convection without powered compression. The Venturi accelerator 106 includes a geometric taper from a larger inlet diameter 142 to a smaller throat diameter 143, causing airflow velocity to increase as air passes through the narrowed region due to pressure differentials created by buoyancy and thermal gradients. This structural acceleration of airflow enables the system 100 to achieve higher volumetric flow rates passively than would be possible with straight, constant-diameter pipes alone. By increasing airflow velocity without mechanical compression or active pumping, the Venturi accelerators 106 support whole-building airflow sufficient for occupant comfort while maintaining the energy-independent nature of the system. Together, the buried geothermal airflow core 102 and the Venturi accelerators 106 cooperate to provide a passive, scalable, and reliable mechanism for transferring thermally conditioned air from the subsurface environment into the building.

In one embodiment, the buried geothermal airflow core 102 includes between three and ten underground air-conveying pipes 104 arranged in a parallel airflow configuration, wherein each of the plurality of underground air-conveying pipes 104 has an internal diameter between 8 inches and 16 inches. The parallel airflow configuration allows air to flow simultaneously through multiple subsurface conduits, thereby increasing total volumetric airflow while reducing pressure losses relative to serial flow arrangements. The specified number of underground air-conveying pipes 104 enables scalability of the system 100 to support different building sizes while maintaining passive airflow characteristics. The disclosed internal diameter range balances airflow capacity with surface-area contact to promote efficient geothermal heat exchange with surrounding soil. Together, the number, arrangement, and dimensions of the underground air-conveying pipes 104 support reliable whole-building airflow without powered compression.

In another embodiment, the at least one Venturi accelerator 106 of each of the plurality of underground air-conveying pipes 104 includes a taper from the inlet diameter 142 to the smaller throat diameter 143 at an angle between 45 degrees and 65 degrees configured to accelerate airflow to between 750 CFM and 1,750 CFM per underground air-conveying pipe. The Venturi accelerator 106 increases airflow velocity through geometric constriction, thereby enhancing airflow generated by natural convection without the use of mechanical blowers or compressors. The selected angle range promotes efficient acceleration while minimizing turbulence and pressure instability. Integration of the Venturi accelerator 106 within each underground air-conveying pipe 104 enables cumulative airflow sufficient for whole-building comfort under passive operation. This configuration allows the system 100 to achieve high airflow performance while preserving energy independence.

In yet another embodiment, the plurality of underground air-conveying pipes 104 are buried at a depth between 2 feet and 8 feet below grade. Placement within this depth range positions the underground air-conveying pipes 104 in soil regions exhibiting relatively stable temperatures across daily and seasonal cycles. Burial at these depths enhances thermal stability and supports consistent heat exchange between the air and surrounding earth. Shallower installations may be subject to greater temperature fluctuation, while deeper installations may increase excavation complexity. Accordingly, the disclosed burial depth range supports efficient geothermal conditioning while accommodating practical installation constraints.

In one embodiment, the system 100 includes a configuration that delivers between 3,900 CFM and 6,100 CFM of conditioned airflow to the building interior. This airflow range is sufficient to support whole-building thermal comfort under passive geothermal operation without reliance on powered compressors. The system 100 achieves this airflow through the combined effects of subsurface heat exchange, Venturi-based airflow acceleration, and controlled routing through the thermal hub 108 and air conveyance assembly 122. Delivery within this range enables balanced temperature distribution across multiple interior spaces while maintaining passive energy independence. The configured airflow range supports residential and light-commercial applications without requiring continuous electrical input.

In another embodiment, the buried geothermal airflow core 102 is encased in a gravel backfill layer 170 that includes a double-sided reflective aluminum foil insulation backer 103. The plurality of underground air-conveying pipes 104 includes a plurality of pipe caps 105, each pipe cap is disposed at a respective lowest subterranean point of a corresponding underground air-conveying pipe 104. Each of the plurality of pipe caps 105 further includes a plurality of weeping holes 107 configured to drain condensation into the gravel backfill layer 170. This configuration promotes gravity-assisted moisture removal while preventing accumulation of water within the underground air-conveying pipes 104. The gravel backfill layer 170 provides both structural support and a drainage medium that enhances long-term system reliability.

In yet another embodiment, the buried geothermal airflow core 102, the thermal hub 108, the climate interface module 118, and the air conveyance assembly 122 are structurally coupled via a plurality of connections 123. Each of the plurality of connections 123 includes a male bevel 175 received within a corresponding female coupling 125. The bevel-and-coupling configuration provides aligned airflow pathways while maintaining secure mechanical engagement between components. This structural coupling method allows modular assembly and disassembly of system components without specialized tools. The coupling arrangement further supports consistent airflow sealing and reduces leakage during passive operation.

In one embodiment, the system 100 includes the thermal hub 108 fluidly coupled to the buried geothermal airflow core 102 and configured to receive air therefrom. The thermal hub 108 includes the at least one air filtration element 110 that removes particulates from the airflow prior to delivery into the building interior. The thermal hub 108 further includes the distribution chamber 112 configured to receive airflow from multiple underground air-conveying pipes 104 and to equalize pressure before downstream routing. This configuration allows conditioned air to be stabilized and directed in a controlled manner under passive operation. The thermal hub 108 thereby functions as a transition point between subsurface geothermal conditioning and above-ground air distribution.

In another embodiment, the thermal hub 108 further includes the plurality of dual gable vents 114 configured to provide a natural draft assist of between 25 CFM and 75 CFM. The plurality of dual gable vents 114 allow pressure equalization between the thermal hub 108 interior and the surrounding ambient environment. This pressure differential enhances airflow generated by natural convection without the use of powered fans. The draft assist contributes to airflow stability across varying thermal and environmental conditions. The plurality of dual gable vents 114 operate continuously as passive airflow-enhancing features.

In yet another embodiment, the thermal hub 108 includes the modular heat-exchange roof cap 116 configured to provide supplemental heating using solar thermal absorption or phase-change materials. The modular heat-exchange roof cap 116 is positioned to receive solar radiation or store thermal energy for transfer to airflow within the thermal hub 108. The modular configuration allows the modular heat-exchange roof cap 116 to be added, removed, or replaced without altering baseline system operation. The modular heat-exchange roof cap 116 supplements geothermal conditioning while preserving passive functionality. The thermal hub 108 continues to operate without the modular heat-exchange roof cap 116 when supplemental heating is not desired. In some embodiments, the system 100 may further include a solar panel 134 physically mounted near the system 100 and electrically coupled to optional auxiliary components to provide off-grid power.

In one embodiment, the system 100 includes the climate interface module 118 fluidly coupled to the thermal hub 108 and configured to deliver conditioned air into an interior space of a building 109. The climate interface module 118 includes the access enclosure 120 fixed to at least one of a wall 126 and a foundation of the building 127. The access enclosure 120 provides a physical interface between the system 100 and the building interior. The access enclosure 120 enables inspection, maintenance, and airflow control without disturbing subsurface or structural components. The climate interface module 118 defines the point at which conditioned air enters occupied spaces.

In another embodiment, the system 100 includes the air conveyance assembly 122 interconnecting the buried geothermal airflow core 102, the thermal hub 108, and the climate interface module 118. The air conveyance assembly 122 includes the exterior vertical wall chase 124 having a length between 5 feet and 10 feet. The air conveyance assembly 122 further includes a conical flexible soffit transition 128 expanding from a first profile 129 to a second profile 130, the second profile 130 is larger than the first profile 129. This configuration is configured to route airflow into an upper cavity of the building 131 while accommodating structural constraints. The air conveyance assembly 122 supports passive airflow delivery across varied building configurations.

In yet another embodiment, the system 100 includes a configuration that delivers whole-building airflow using passive geothermal heat exchange with no continuous electricity consumption during normal operation after installation. Airflow is generated through the combined effects of subsurface thermal gradients, Venturi-based acceleration, and passive draft features. The system 100 maintains conditioned airflow without reliance on powered compressors or continuous electrical devices. As a result, the system 100 provides energy-independent climate conditioning for residential and light-commercial buildings.

Turning now to FIG. 1D, which is a cross-sectional schematic view of a passive geothermal airflow device 132, in accordance with a preferred embodiment of the invention. The passive geothermal airflow device 132 includes a plurality of hollow subterranean conduits 104 and each of the plurality of hollow subterranean conduits 104 includes the at least one Venturi airflow accelerator 106. The passive geothermal airflow device 132 includes a surface-mounted air handling enclosure 135 including an air filtration section 136. The passive geothermal airflow device 132 includes a building interface outlet 137.

In another embodiment, the device 132 includes the plurality of hollow subterranean conduits 104, each sized to convey ambient air and exchange heat with surrounding earth. The hollow subterranean conduits 104 are positioned below the ground 141 to take advantage of stable subsurface temperatures that condition airflow as it passes through the conduits. Thermal energy is transferred between the surrounding soil and the airflow through the conduit walls, thereby warming or cooling the air depending on environmental conditions. The hollow subterranean conduits 104 provide the primary geothermal heat-exchange path within the device 132. Arrangement of multiple hollow subterranean conduits 104 supports increased airflow capacity and enhanced thermal exchange.

In yet another embodiment, the plurality of hollow subterranean conduits 104 are fabricated from polymeric or composite materials selected to reduce internal friction and moisture accumulation. These materials provide smooth interior surfaces that minimize airflow resistance and promote efficient passive airflow. The selected materials also resist corrosion and degradation when installed in subterranean environments. Reduced moisture retention within the hollow subterranean conduits 104 mitigates condensation-related issues over long periods of operation. Material selection therefore contributes to durability and long-term performance of the device 132.

In one embodiment, the at least one Venturi airflow accelerator 106 is disposed within each of the plurality of hollow subterranean conduits 104 and configured to increase airflow velocity under natural convection conditions. The at least one Venturi airflow accelerator 106 increases airflow velocity through geometric shaping of the internal passage without powered compression. This passive acceleration enhances total airflow generated by thermal buoyancy and pressure differentials. Integration of the at least one Venturi airflow accelerator 106 within each hollow subterranean conduit 104 enables cumulative airflow sufficient for whole-building conditioning. The at least one Venturi airflow accelerator 106 operates continuously under passive conditions.

In another embodiment, the at least one Venturi airflow accelerator 106 of each of the plurality of hollow subterranean conduits 104 includes a taper from the inlet diameter 142 to the smaller throat diameter 143. The tapered geometry causes airflow to accelerate as it passes through the constricted throat region. This acceleration occurs due to pressure differentials created by natural convection rather than mechanical force. The taper geometry is selected to balance airflow speed with stability and reduced turbulence. As a result, the at least one Venturi airflow accelerator 106 provides efficient, passive airflow enhancement.

In yet another embodiment, the surface-mounted air handling enclosure 135 is fluidly coupled to the plurality of hollow subterranean conduits 104. The surface-mounted air handling enclosure 135 includes an air filtration section 136 configured to remove particulates from the airflow prior to delivery into occupied spaces. The enclosure collects airflow from multiple hollow subterranean conduits 104 and stabilizes pressure before downstream routing. Placement at a surface location allows convenient access and integration with building structures. The surface-mounted air handling enclosure 135 forms an interface between subterranean conditioning and interior air delivery.

In one embodiment, the surface-mounted air handling enclosure 135 includes a removable filter tray 138. The removable filter tray 138 allows filter elements to be replaced or serviced without disassembling the surface-mounted air handling enclosure 135 or subterranean components. This feature supports routine maintenance while preserving passive operation. The removable filter tray 138 is accessible from the exterior or interior depending on installation. Removability reduces long-term service complexity.

In another embodiment, the building interface outlet 137 is configured to convey air from the surface-mounted air handling enclosure 135 into an occupied space. The building interface outlet 137 defines the transition point between the device 132 and interior environments. It directs conditioned air into one or more interior zones of the building. The building interface outlet 137 is positioned to support controlled airflow delivery. This component facilitates integration with existing building layouts.

In yet another embodiment, the building interface outlet 137 includes an insulated duct section 139 configured for retrofit installation. The insulated duct section 139 reduces thermal losses during air delivery into the building. Insulation also mitigates condensation and noise transmission. The insulated duct section 139 accommodates installation in existing structures without major structural modification. This supports adaptability of the device 132 to retrofit environments.

In one embodiment, the device 132 is configured to operate as a self-contained air conditioning and heating apparatus without powered compressors or refrigerants. Conditioning of air is achieved through geothermal heat exchange and passive airflow mechanisms. The device 132 functions independently of active refrigeration cycles. This configuration reduces energy consumption and maintenance requirements. The device 132 remains operational during power interruptions.

In another embodiment, the device 132 also includes at least one auxiliary component 183 selected from the group consisting of a fan 184 and a heater 140, wherein the at least one auxiliary component 183 is selectively operable and not required for baseline operation. The at least one auxiliary component 183 may be activated under specific conditions to supplement passive airflow or heating. The at least one auxiliary component 183 does not alter the fundamental passive operation of the device 132. When inactive, airflow and conditioning continue through geothermal and passive mechanisms. This optional configuration provides flexibility while preserving energy independence.

FIG. 1E illustrates a top-down cross-sectional view of the buried geothermal airflow core 102 configured as a five-pipe GeoFlow Core, in accordance with a preferred embodiment of the present invention. The buried geothermal airflow core 102 includes the plurality of underground air-conveying pipes 104 arranged in a parallel airflow configuration, with one underground air-conveying pipe 104 located centrally and four underground air-conveying pipes 104 positioned around the central pipe. Each underground air-conveying pipe 104 is shown with a circular cross-section corresponding to a hollow interior passage configured to convey airflow while exchanging heat with surrounding soil. The illustrated arrangement provides uniform spacing between adjacent underground air-conveying pipes 104, supporting balanced airflow distribution and increased geothermal heat-exchange surface area. The outer square boundary represents an excavation or containment region defining the footprint of the buried geothermal airflow core 102.

In the embodiment shown in FIG. 1E, the regions between the underground air-conveying pipes 104 include a gravel backfill layer 170, such as pea gravel, which stabilizes the pipes and promotes subsurface drainage. Furthermore, each of the underground air-conveying pipe 104 may include the at least one internal Venturi accelerator 106 extending along a portion of the pipe length to enhance airflow under natural convection conditions. The parallel arrangement allows air to flow simultaneously through all five underground air-conveying pipes 104, increasing total volumetric airflow while maintaining low pressure loss.

FIG. 1F illustrates a close-up cutaway view of an upper portion of the buried geothermal airflow core 102, showing a plurality of underground air-conveying pipes 104 and the associated Venturi accelerators 106 integrated therein, in accordance with a preferred embodiment of the present invention. The cutaway view exposes the upper end regions of multiple underground air-conveying pipes 104 as they terminate within the buried geothermal airflow core 102. Each underground air-conveying pipe 104 includes the at least one Venturi accelerator 106 formed near the pipe outlet, with the Venturi accelerator 106 having a contoured, tapered geometry that transitions from the inlet diameter 142 of the underground air-conveying pipe 104 toward a reduced throat region. The illustrated arrangement shows the Venturi accelerators 106 oriented to direct airflow upward as air exits the underground air-conveying pipes 104. This figure highlights the placement of the Venturi accelerators 106 at the top of the buried geothermal airflow core 102, prior to airflow entering downstream components.

In the embodiment shown in FIG. 1F, each Venturi accelerator 106 is configured to increase airflow velocity generated by natural convection within the corresponding underground air-conveying pipe 104, without powered compression. The converging geometry of the Venturi accelerator 106 accelerates airflow as it approaches the outlet of the underground air-conveying pipe 104, thereby reducing static pressure and promoting increased volumetric airflow under passive operation. The plurality of Venturi accelerators 106 operate in parallel, corresponding to the parallel arrangement of the underground air-conveying pipes 104 within the buried geothermal airflow core 102. The surrounding structure shown beneath the Venturi accelerators represents a housing or structural portion of the buried geothermal airflow core 102 that maintains alignment and spacing of the underground air-conveying pipes 104.

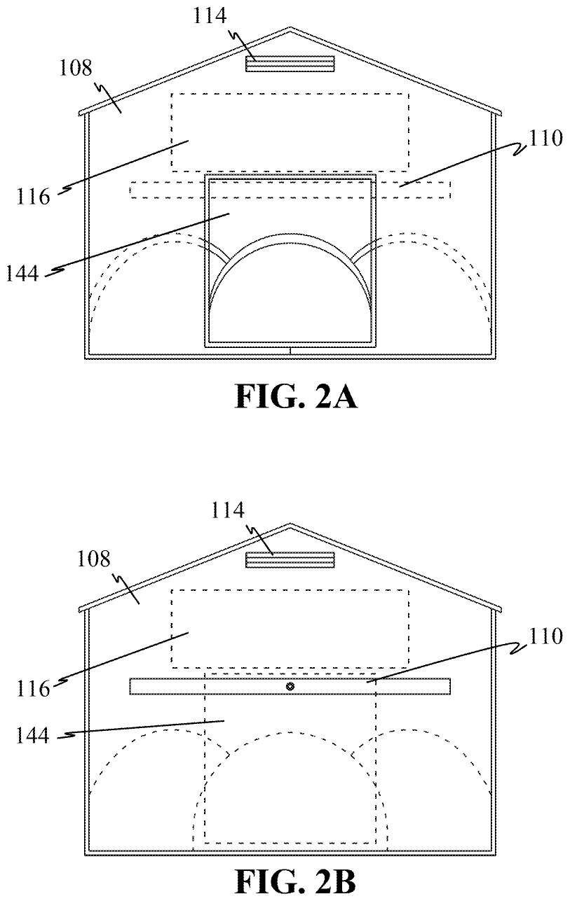

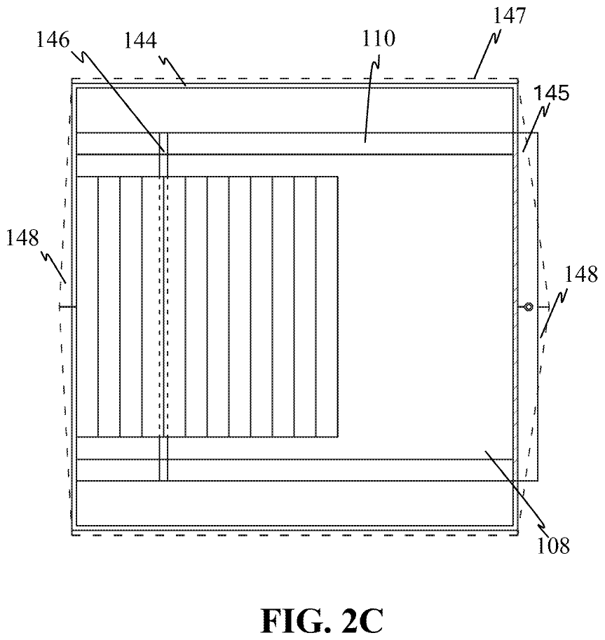

FIG. 2A illustrates a front cutaway view of the thermal hub 108 of the passive geothermal heating and cooling system 100, showing internal airflow handling and conditioning components, in accordance with a preferred embodiment. The thermal hub 108 is configured as a housing structure that receives conditioned air from the plurality of underground air-conveying pipes 104 positioned at a lower portion of the thermal hub 108. Dashed airflow paths depict air entering the thermal hub 108 from the underground air-conveying pipes 104 and rising upward into an interior volume. The air filtration element 110, implemented as a filter tray, is positioned within the thermal hub 108 to remove particulates from the incoming air prior to downstream distribution.

In the embodiment shown in FIG. 2A, the thermal hub 108 further includes a thermal hub top 147, which defines an upper structural portion of the thermal hub enclosure. The thermal hub top 147 supports the plurality of gable vents 114 configured to provide passive draft assistance and pressure equalization. Each gable vent 114 enables controlled air exchange between the interior of the thermal hub 108 and the surrounding environment, thereby enhancing airflow generated by natural convection and stabilizing internal pressure conditions during passive operation.

FIG. 2B illustrates a rear cutaway view of the thermal hub 108, complementary to the front cutaway view of FIG. 2A, in accordance with a preferred embodiment. The rear cutaway shows conditioned air entering the thermal hub 108 from the plurality of underground air-conveying pipes 104 at a lower region and rising upward through the interior volume, as indicated by dashed arcuate airflow paths. The air filtration element 110 is shown extending generally horizontally across an interior portion of the thermal hub 108, positioned to intercept and filter air moving upward prior to entry into an upper airflow region.

In the embodiment illustrated in FIG. 2B, the thermal hub 108 further includes a PVC panel 144 forming a rear structural wall of the thermal hub housing. A filter tray access door 145 is provided in the PVC panel 144 to permit selective access to the air filtration element 110 for inspection, cleaning, or replacement. The air filtration element 110 is supported by at least one filter tray brace 146, which maintains the filter tray in a fixed and aligned position during airflow operation. The upper rear portion of the thermal hub 108 includes the gable end of the thermal hub top 148, which forms a structural termination of the thermal hub top 147 and supports the arrangement of the gable vents 114.

FIG. 2C illustrates a partial interior perspective view of the thermal hub 108, emphasizing the cooperative arrangement of the air filtration element 110, the PVC panel 144, and the filter tray access door 145, in accordance with a preferred embodiment. The filter tray brace 146 is shown supporting the air filtration element 110 within the thermal hub 108 while maintaining alignment with airflow originating from the underground air-conveying pipes 104. The filter tray access door 145 enables the air filtration element 110 to be slidably removed through the PVC panel 144 without disassembly of the thermal hub 108.

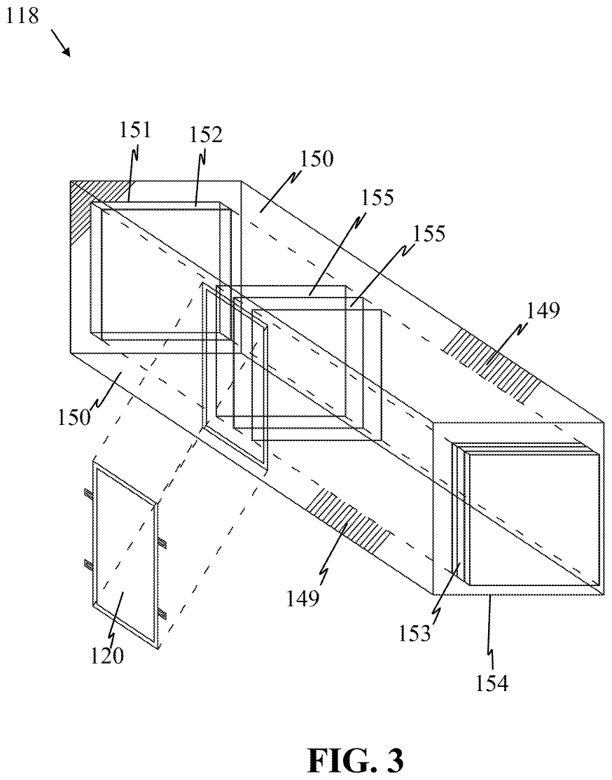

FIG. 3 illustrates an exploded perspective view of the climate interface module 118, in accordance with a preferred embodiment. The climate interface module 118 includes an elongated housing defining an internal airflow passage extending between opposing ends of the module. The module is configured to interface with upstream air conveyance components and to discharge conditioned air into the building through a controlled outlet. Dashed lines within the module indicate the internal airflow path through the housing.

The climate interface module 118 includes a pipe insulation 149 disposed along exterior wall portions of the housing to reduce thermal losses and mitigate condensation as conditioned air passes through the module. A space for insulation between pipe 150 is defined between an inner airflow conduit and an outer wall of the module, allowing insulation material to be positioned without obstructing airflow. At an inlet side of the module, an internal female collar 151 is provided to receive a mating air conveyance component, the internal female collar 151 including a bevel female 152 configured to engage a corresponding beveled male connector. At an outlet side of the module, a bevel male 153 is provided for coupling to a downstream component or interior discharge interface. An outer shell 154 surrounds the internal airflow passage and insulation space, providing structural rigidity and environmental protection.

The climate interface module 118 further includes one or more trace slots for fan and/or heater 155 formed in an interior portion of the housing. The trace slots 155 are configured to receive optional auxiliary components, such as a fan or heater, without being required for baseline passive operation. An access enclosure 120 is shown detached from the module, the access enclosure 120 being selectively attachable to the outer shell 154 to permit access to the internal airflow passage and trace slots 155 for inspection, installation, or maintenance of optional components.

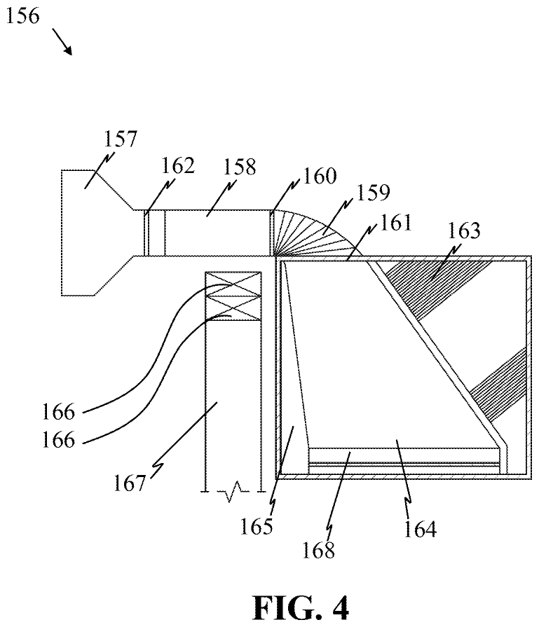

FIG. 4 illustrates a sectional view of an AeroDuct soffit transition assembly 156 configured to route conditioned air from an upstream air conveyance path upward through a soffit and into an upper cavity of a building, in accordance with a preferred embodiment. The AeroDuct soffit transition assembly 156 includes a round transition reducer 157 positioned at an upstream end to convert a round airflow profile into a rectangular or transitional geometry suitable for downstream duct components. The round transition reducer 157 is fluidly coupled to a pipe 158, the pipe 158 being approximately 10 inches long, 3 inches tall, and 12 inches wide, and including a female end that is approximately 2 inches long with a corresponding female bevel formed at approximately 1 inch. The opposite end of the pipe 158 is fused to a flexible increaser 159, which permits gradual expansion and directional redirection of airflow to accommodate soffit geometry and installation constraints.

As shown, the connection between the pipe 158 and the flexible increaser 159 is formed by a fused joint 160, providing a sealed and structurally fixed interface that maintains airflow continuity. Downstream of the flexible increaser 159, the assembly includes an aero duct soffit trim collar 161, which defines a finished interface between the airflow components and the soffit opening of the building. A beveled joint 162 is provided between adjacent duct components to facilitate aligned coupling and sealed engagement. A molded insulation block 163 is disposed along an interior portion of the aero duct soffit trim collar 161 to reduce thermal losses and mitigate condensation as conditioned air is routed into the attic space.

The AeroDuct soffit transition assembly 156 further includes a metal reducer 164 configured to transition airflow from a larger cross-section of approximately 12 inches by 12 inches to a smaller cross-section of approximately 5 inches by 12 inches for compatibility with downstream attic-level ducting. A space wall side 165, having a width of approximately 2 inches, is provided between the assembly and a structural boundary to allow positional adjustment during installation. For illustrative purposes, the figure shows a plate 166 and a wall 167, each representing a simulated structural wall within the building envelope. At a downstream end of the assembly, an intake opening 168 is provided, the intake opening 168 including a 2-inch female interior end with a corresponding female bevel formed at approximately 1 inch inside, enabling sealed coupling to attic-level air distribution components.

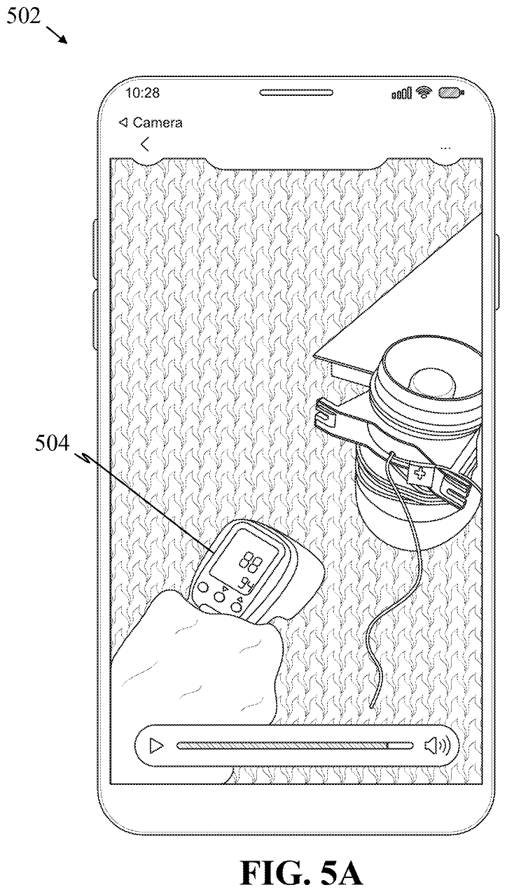

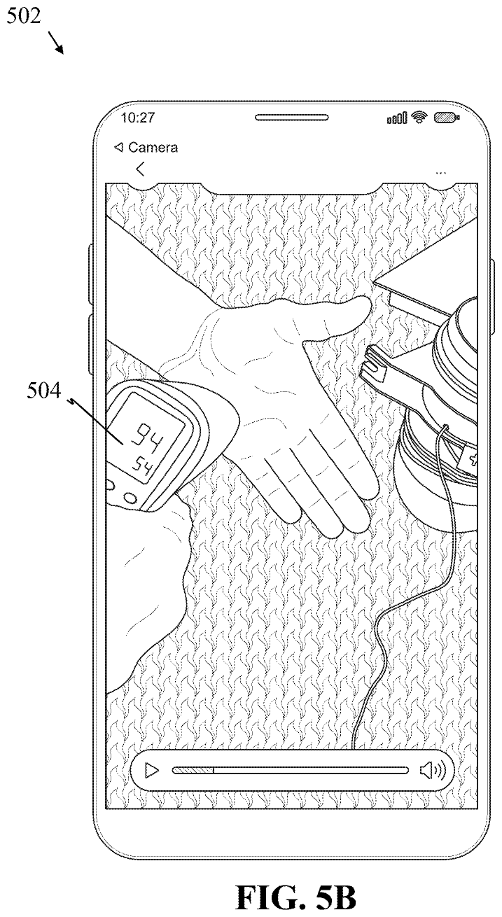

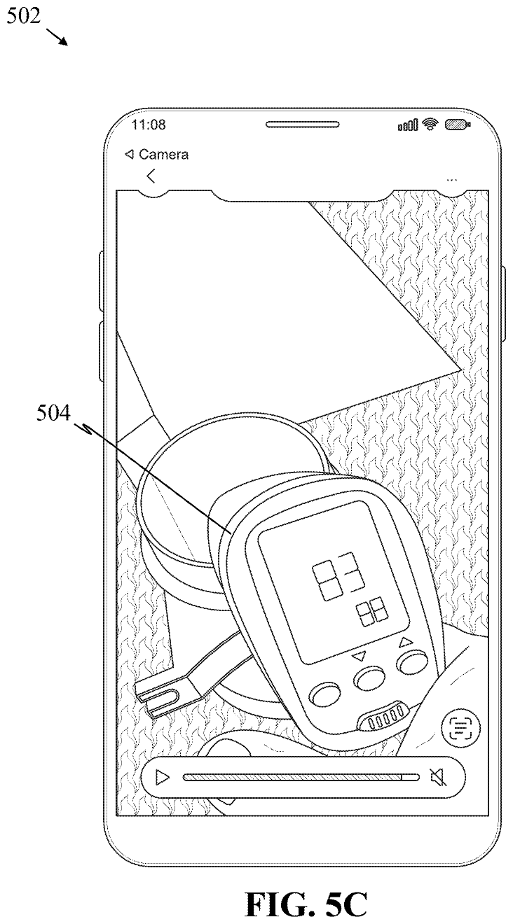

FIGS. 5A, 5B, and 5C collectively illustrate a 1/12-scale experimental mock-up of the passive geothermal heating and cooling system used by the inventor to evaluate airflow and thermal performance during a controlled testing phase. The experimental mock-up represents a scaled physical model of the system architecture, including subsurface airflow routing and vent discharge, constructed to observe temperature differentials achieved through passive geothermal operation. A user-operated mobile device 502 is shown capturing visual documentation of the test conditions, while a handheld sensing instrument 504 is used to measure temperature values at defined test points. These figures document empirical validation of the system concept rather than operational monitoring of a deployed system.

In FIG. 5A, the handheld sensing instrument 504 is positioned to measure a baseline ground temperature associated with the simulated subterranean environment of the mock-up. This measurement establishes a reference thermal condition corresponding to ground-level or subsurface temperature prior to airflow conditioning. In FIG. 5B, the handheld sensing instrument 504 is used to obtain an ambient reference temperature measurement, representing the surrounding air temperature external to the mock-up and independent of geothermal influence. This ambient measurement provides a comparative baseline against which system-conditioned airflow can be evaluated. In FIG. 5C, the handheld sensing instrument 504 is positioned adjacent a discharge vent of the experimental mock-up to measure the discharge air temperature, thereby demonstrating the thermal effect achieved by routing air through the passive geothermal airflow path.

Together, FIGS. 5A-5C document the scaled experimental validation of the passive geothermal heating and cooling system by comparing baseline ground temperature, ambient air temperature, and discharged conditioned air temperature. The experimental setup confirms that the system produces a measurable temperature differential using passive geothermal heat exchange without powered refrigeration or compression. The user-operated mobile device 502 serves solely as a documentation tool for recording the experimental observations and does not form part of the operational system. These figures therefore provide empirical support for the feasibility and performance of the disclosed passive geothermal architecture.

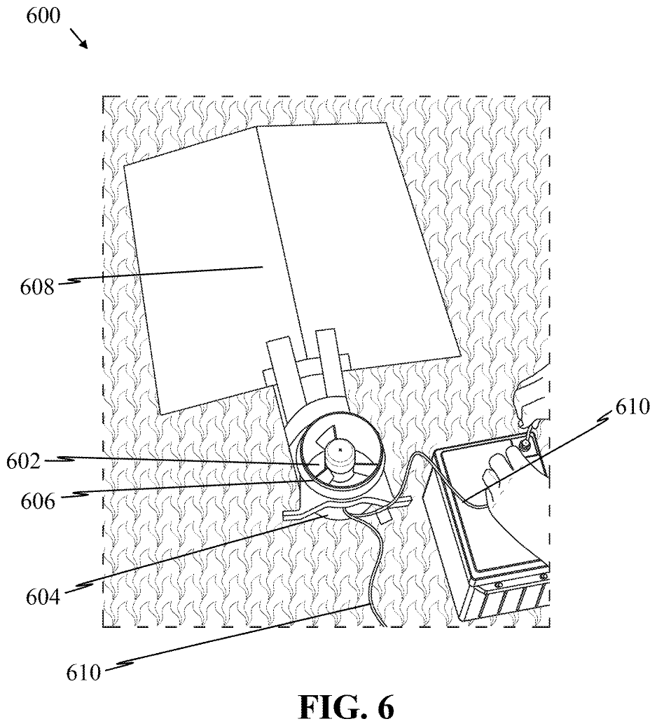

FIG. 6 illustrates an observation setup 600 used to evaluate operation of the system 100 during passive or supplemental airflow conditions, in accordance with an embodiment. FIG. 6 shows a surface-mounted airflow interface or outlet 602 coupled to an upstream conduit 604, with a sensing device 606 positioned proximate to the outlet 602 to measure airflow or temperature characteristics. A movable panel or shroud 608 is shown adjacent to the outlet 602, indicating that airflow direction or exposure may be adjusted during testing or observation. A set of electrical leads 610 connected to the sensing device 606 indicate that measurement is performed using an external instrument independent of the system 100 itself.

In some embodiments, the setup shown in FIG. 6 may be used during commissioning, diagnostics, or demonstration of system functionality, including confirmation of airflow generation under passive operation or during selective use of optional auxiliary components. The sensing device may measure parameters such as air velocity, temperature, or volumetric flow rate while the system remains structurally passive. The illustrated arrangement further indicates that user-operated adjustments, such as repositioning the shroud or panel, may be employed to assess airflow distribution or directionality. Importantly, the system does not rely on the sensing device for normal operation, control, or regulation of airflow.

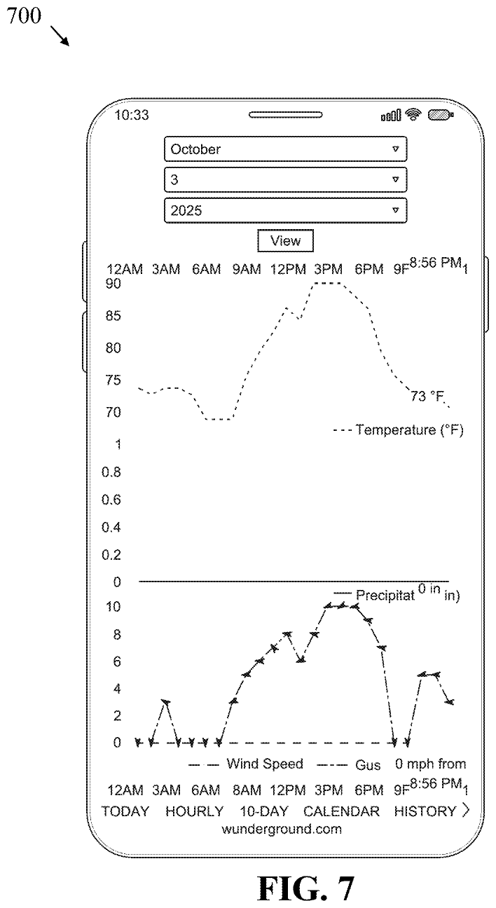

FIG. 7 illustrates an example external environmental data display 700 presented on a user-operated mobile device, showing historical and time-based atmospheric conditions relevant to operation of the passive geothermal system, in accordance with an embodiment. The displayed interface includes selectable temporal inputs, such as date and time ranges, along with plotted environmental parameters including ambient temperature, precipitation, and wind speed. The graphical representation shows diurnal temperature variation and wind conditions over a selected period, providing contextual information regarding external environmental influences. Such data may be referenced during system evaluation, installation planning, or performance verification to correlate system with surrounding ambient conditions. The mobile device functions independently of the system and does not provide control or regulation of airflow.

In some embodiments, the environmental data shown in FIG. 7 may be used for analysis or documentation of system performance under varying weather conditions, particularly during commissioning or comparative studies. For example, ambient temperature and wind speed data may be compared against observed indoor airflow or temperature conditions to validate passive operation effectiveness. The display emphasizes that system performance assessment can incorporate publicly available or third-party environmental data sources without requiring integrated sensing or electronics within the system. This approach preserves the passive and energy-independent nature of the system while allowing informed evaluation using external tools. FIG. 7 therefore illustrates an example context-monitoring interface that supports analysis and validation of passive geothermal conditioning without altering system structure or operation.

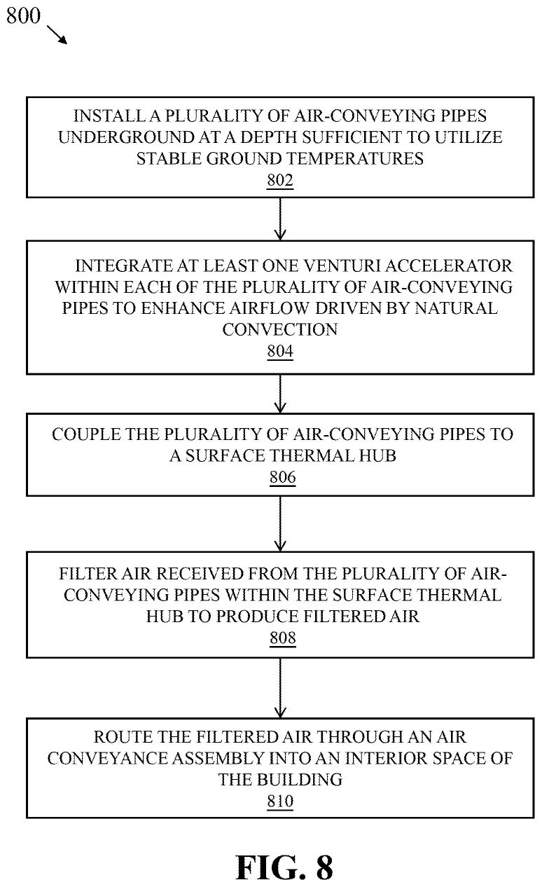

FIG. 8 illustrates a flow chart of a method 800 of providing passive geothermal heating and cooling to a building, in accordance with an embodiment.

At step 802, the method includes installing a plurality of air-conveying pipes underground at a depth sufficient to utilize stable ground temperatures. The air-conveying pipes are positioned below grade so that they are exposed to subsurface soil regions where temperature variation is minimized across daily and seasonal cycles. Placement at such depths allows ambient air flowing through the pipes to exchange heat with the surrounding earth, thereby cooling the air in warmer conditions and warming the air in cooler conditions. Multiple pipes may be installed in parallel to increase total airflow capacity and heat-exchange surface area. This step establishes the subsurface thermal conditioning foundation for passive operation of the system.

At step 804, the method includes integrating at least one Venturi accelerator within each of the plurality of air-conveying pipes to enhance airflow driven by natural convection. Each Venturi accelerator is formed as a geometric taper within the internal flow path of a corresponding pipe, causing airflow velocity to increase as air passes through the narrowed region. This acceleration occurs due to pressure differentials generated by thermal buoyancy rather than by mechanical compression. Integration of the Venturi accelerators enables higher volumetric airflow rates than would be achieved by straight pipes alone. As a result, the system can passively generate airflow sufficient for whole-building conditioning.

At step 806, the method includes coupling the plurality of air-conveying pipes to a surface thermal hub. The thermal hub receives airflow from the underground pipes and functions as a transition point between subsurface conditioning components and above-ground air-handling components. Coupling may be achieved using modular connections that align airflow paths and maintain sealed interfaces. The thermal hub aggregates airflow from multiple pipes into a controlled distribution volume. This step enables stabilized airflow management prior to delivery into the building.

At step 808, the method includes filtering air received from the plurality of air-conveying pipes within the surface thermal hub to produce filtered air. An air filtration element positioned within the thermal hub removes particulates from the airflow before it enters occupied spaces. Filtration improves indoor air quality while protecting downstream components from debris accumulation. The filtering operation is performed without materially impeding passive airflow. This step ensures that conditioned air delivered into the building is suitable for occupant use.

At step 810, the method includes routing the filtered air through an air conveyance assembly into an interior space of the building. The air conveyance assembly directs airflow from the thermal hub through ducts, wall chases, or transition structures to reach one or more interior regions. The assembly may include vertical and horizontal sections configured to accommodate building geometry while minimizing airflow resistance. Conditioned air is thereby delivered into occupied spaces using passive airflow mechanisms. This step completes delivery of geothermal-conditioned air into the building interior without powered refrigeration or compressors.

The steps 802 to 810 are only illustrative and other alternatives may also be provided where one or more steps are added, one or more steps are removed, or one or more steps are provided in a different sequence without departing from the scope of the claims herein.

In some embodiments, the method 800 provides continuous air conditioning without powered refrigeration or compressors. Conditioning of air is achieved through geothermal heat exchange within the underground air-conveying pipes and passive airflow mechanisms enhanced by Venturi acceleration. Airflow is sustained by natural convection, pressure differentials, and passive draft effects rather than mechanical compression. As a result, the method 800 enables long-term operation with minimal energy consumption and reduced maintenance requirements. This passive configuration allows conditioned air to be delivered continuously to the building interior regardless of grid availability.

In some embodiments, the air conveyance assembly is routed through a vertical wall chase within the building. The vertical wall chase provides a protected and space-efficient pathway for conveying conditioned air from the thermal hub to upper or interior regions of the structure. Routing the air conveyance assembly through the wall chase supports retrofit installation without requiring significant structural modification. The vertical orientation further promotes natural buoyancy-driven airflow, enhancing passive distribution. This configuration enables flexibility in delivering conditioned air to different building layouts and elevations.

In some embodiments, the method 800 also includes attaching a modular heat-exchange cap to the surface thermal hub to provide supplemental heating. The heat-exchange cap may utilize solar thermal absorption or phase-change materials to introduce additional thermal energy into the airflow when desired. Attachment of the modular heat-exchange cap does not interrupt baseline passive geothermal operation and may be performed selectively based on climate conditions. The modular nature of the cap allows it to be added, removed, or replaced without altering core system components. This step provides optional heating enhancement while preserving the passive and energy-independent characteristics of the method 800.

It is to be understood that embodiments may be made, other than those mentioned, and structural and functional modifications may be made without departing from the scope of the present invention.

It may be appreciated that reference throughout this specification to “one embodiment” or “an embodiment” or “an aspect” or features included as “may” means that a particular feature, structure or characteristic described in connection with the embodiments is included in at least one embodiment of the present invention. Furthermore, the particular features, structures or characteristics may be combined as suitable in one or more embodiments of the present invention. The previous description is provided to enable any person skilled in the art to practice the various aspects described herein. Various modifications to these aspects will be readily apparent to those skilled in the art, and the generic principles defined herein may be applied to other aspects.

Modifications to embodiments of the present invention described in the foregoing are possible without departing from the scope of the present invention as defined by the accompanying claims. Expressions such as “including”, “comprising”, “incorporating”, “have”, “is” used to describe and claim the present invention are intended to be construed in a non-exclusive manner, namely allowing for items, components or elements not explicitly described also to be present. Reference to the singular is also to be construed to relate to the plural.

What is claimed is:

1. A passive geothermal heating and cooling system comprising:
a buried geothermal airflow core including a plurality of underground air-conveying pipes, each of the plurality of underground air-conveying pipes configured to exchange heat with surrounding soil and each of the plurality of underground air-conveying pipes including at least one Venturi accelerator configured to increase airflow generated by natural convection without powered compression;
a thermal hub fluidly coupled to the buried geothermal airflow core and configured to receive air therefrom, the thermal hub including at least one air filtration element and a distribution chamber;
a climate interface module fluidly coupled to the thermal hub and configured to deliver conditioned air into an interior space of a building; and
an air conveyance assembly interconnecting the buried geothermal airflow core, the thermal hub, and the climate interface module;
wherein the system is configured to deliver whole-building airflow using passive geothermal heat exchange with no continuous electricity consumption during normal operation after installation.

2. The system of claim 1, wherein the buried geothermal airflow core comprises between three and ten underground air-conveying pipes arranged in a parallel airflow configuration, and wherein each of the plurality of underground air-conveying pipes has an internal diameter between 8 inches and 16 inches.

3. The system of claim 1, wherein the at least one Venturi accelerator of each of the plurality of underground air-conveying pipes comprises a taper from an inlet diameter to a smaller throat diameter at an angle between 45 degrees and 65 degrees configured to accelerate airflow to between 750 CFM and 1,750 CFM per underground air-conveying pipe.

4. The system of claim 1, wherein the plurality of underground air-conveying pipes are buried at a depth between 2 feet and 8 feet below grade.

5. The system of claim 1, wherein the thermal hub further comprises dual gable vents configured to provide a natural draft assist of between 25 CFM and 75 CFM.

6. The system of claim 1, wherein the thermal hub includes a modular heat-exchange roof cap configured to provide supplemental heating using solar thermal absorption or phase-change materials.

7. The system of claim 1, wherein the climate interface module includes an access enclosure fixed to at least one of a wall and a foundation of the building.

8. The system of claim 1, wherein the air conveyance assembly comprises an exterior vertical wall chase having a length between 5 feet and 10 feet and a conical flexible soffit transition expanding from a first profile to a second profile, wherein the second profile is larger than the first profile, configured to route airflow into an upper cavity of the building.

9. The system of claim 1, wherein the system is configured to deliver between 3,900 CFM and 6,100 CFM of conditioned airflow.

10. The system of claim 1, wherein the buried geothermal airflow core is encased in a gravel backfill layer comprising a double-sided reflective aluminum foil insulation backer, and wherein the plurality of underground air-conveying pipes comprise a plurality of pipe caps, each of the plurality of pipe caps disposed at a respective lowest subterranean point of a corresponding one of the plurality of underground air-conveying pipes, each of the plurality of pipe caps further comprising a plurality of weeping holes configured to drain condensation into the gravel backfill layer.

11. The system of claim 1, wherein the buried geothermal airflow core, the thermal hub, the climate interface module, and the air conveyance assembly are structurally coupled via a plurality of connections, each of the plurality of connections comprising a male bevel received within a corresponding female coupling.

12. A passive geothermal airflow device comprising:
a plurality of hollow subterranean conduits each sized to convey ambient air and exchange heat with surrounding earth;
at least one Venturi airflow accelerator disposed within each of the plurality of hollow subterranean conduits and configured to increase airflow velocity under natural convection conditions;
a surface-mounted air handling enclosure fluidly coupled to the plurality of hollow subterranean conduits, the surface-mounted air handling enclosure including an air filtration section;
a building interface outlet configured to convey air from the surface-mounted air handling enclosure into an occupied space;
wherein the device is configured to operate as a self-contained air conditioning and heating apparatus without powered compressors or refrigerants.

13. The device of claim 12, wherein the at least one Venturi airflow accelerator of each of the plurality of hollow subterranean conduits comprises a taper from an inlet diameter to a smaller throat diameter.

14. The device of claim 12, wherein the plurality of hollow subterranean conduits are fabricated from polymeric or composite materials selected to reduce internal friction and moisture accumulation.

15. The device of claim 12, wherein the surface-mounted air handling enclosure includes a removable filter tray.

16. The device of claim 12, wherein the building interface outlet includes an insulated duct section configured for retrofit installation.

17. The device of claim 12, further comprising at least one auxiliary component selected from the group consisting of a fan and a heater, wherein the at least one auxiliary component is selectively operable and not required for baseline operation.

18. A method of providing passive geothermal heating and cooling to a building, comprising:
installing a plurality of air-conveying pipes underground at a depth sufficient to utilize stable ground temperatures;
integrating at least one Venturi accelerator within each of the plurality of air-conveying pipes to enhance airflow driven by natural convection;
coupling the plurality of air-conveying pipes to a surface thermal hub;
filtering air received from the plurality of air-conveying pipes within the surface thermal hub to produce filtered air;
routing the filtered air through an air conveyance assembly into an interior space of the building;
wherein the method provides continuous air conditioning without powered refrigeration or compressors.

19. The method of claim 18, wherein the air conveyance assembly is routed through a vertical wall chase within the building.

20. The method of claim 18, further comprising attaching a modular heat-exchange cap to the surface thermal hub to provide supplemental heating.
